(19) United States
(12) Patent Application Publication
(10) Pub. No.: US 2004/0155170 A1
(43) Pub. Date: Aug. 12, 2004

(54) Vehicle display flag with support assembly

(76) Inventor: Jeffrey D. Thompson, Cedar Springs, MI (US)

Correspondence Address: Shaun P. Montana, Bromberg & Sunstein LLP, 125 Summer Street, Boston, MA, 02110-1618, US

(21) Appl. No.: 10/706,833

(22) Filed: Nov. 12, 2003

Related U.S. Application Data
(60) Provisional application No. 60/425,793, filed on Nov. 13, 2002.

(51) Int. Cl. H01Q 1/12

(52) U.S. Cl. 248/534

(57) ABSTRACT

A display assembly holds a flag upright for display at all times through use of a horizontal support bar. The horizontal support bar may include a gripping collar. The display assembly includes a mast of a certain diameter and a mounting bracket. The gripping collar fits securely onto the mast, so that the horizontal support bar is coupled to the display assembly. When a flag is simultaneously attached to both the mast of the assembly and the horizontal support bar, the flag remains upright. The assembly can be mounted to a fixture, such as the window of an automobile, by a mounting bracket or other similar device.

### PRIORITY

The present application claims priority from U.S. Provisional Application Serial No. 60/425,793, which received a filing date of Nov. 13, 2002, and which is incorporated herein by reference.

### TECHNICAL FIELD AND BACKGROUND ART

The present invention relates to the field of display assemblies, and in particular to a flag display with a support assembly.

Vehicle display flags, commonly sported by fans of football teams, for example, are typically attached, via a pole and window-mounting bracket, to a the window frame of a car such that when the vehicle is in motion, the entire flag can easily be seen, as the moving air will hold it up. If the vehicle is not moving, however, the flag will be limp and not easily viewed.

### SUMMARY OF THE INVENTION

In a first embodiment of the invention there is provided a display assembly having a support structure with two ends. The display assembly also has a horizontal support bar with a gripping collar. While one end of the support structure is for coupling to a fixture, the opposite end of the support structure serves as a mast. The gripping collar on the horizontal support bar can be coupled to the mast in such as way that the horizontal support bar rotates about the axis of the mast. Additionally, the mounting device may include a bracket. Further, the mast may have a guide stop that passes all the way through the gripping collar and a receiver space that fits inside the gripping collar. The receiver space may be characterized by a diameter smaller than the diameter of the mast.

In other embodiments of the invention, the gripping collar of the horizontal support bar may have an inner diameter that is smaller than the outer diameter of the mast, while the guide stop may have a diameter larger than the inner diameter of the gripping collar. Further, a display may be simultaneously coupled to the mast and the horizontal support bar, and the display may be a flag. Further, the support structure and the horizontal support bar may be composed of a solid material. Additionally, the horizontal support bar and the gripping collar may be a single integral component, as may the mounting device and the mast.

### BRIEF DESCRIPTION OF THE DRAWINGS

The foregoing features of the invention will be more readily understood by reference to the following detailed description, taken with reference to the accompanying drawings, in which:

FIG. 1 is a side perspective view of the invention, with a display attached.

FIG. 2 is a magnified view of the connection between a mast and a horizontal support bar.

FIG. 3 is a magnified view of a mast and a horizontal support bar that are not connected.

### DETAILED DESCRIPTION OF SPECIFIC EMBODIMENTS

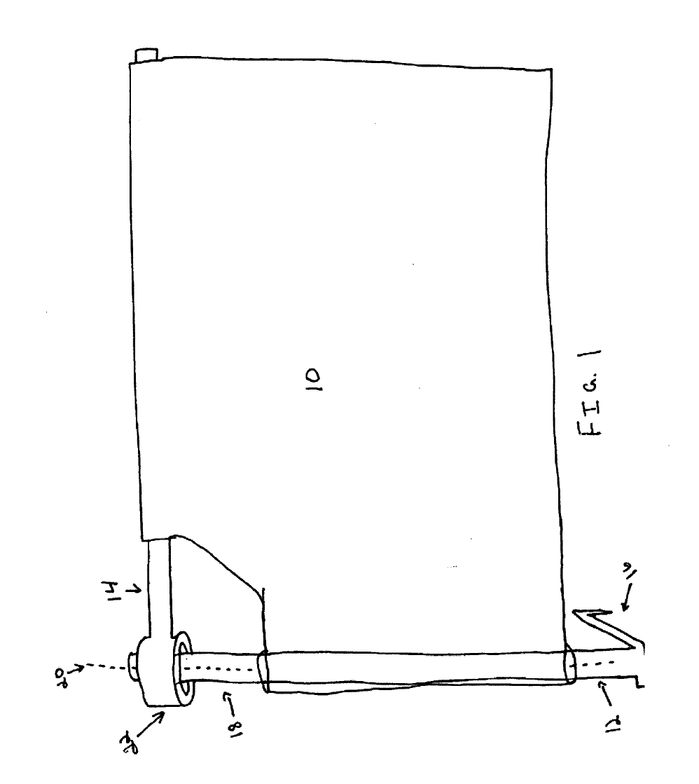

FIG. 1 shows the current invention with an attached display 10. Display 10 may be, for example, a flag, or any other display device that is capable of being coupled to the current invention. Display 10 is simultaneously attached to a support structure 12 and a horizontal support bar 14, which includes a gripping collar 22. Support structure 12 has two ends.

The first end of support structure 12 can be coupled to a fixture, where the term “fixture”, as used herein and in any appended claims, refers to a structure having another purpose that incidentally may support the attached display. Examples of “fixtures”, for the present purpose, include cars, bicycles, or other vehicles, as well as stationary structures such as a lamppost. That end may either be attached to a mounting device or may itself be a mounting device. FIG. 1 shows an example of the first end, a mounting device 16, which may be, for example, a bracket, or any other device that is capable of coupling support structure 12 to any appropriate fixture. The second end of support structure 12 is a mast 18, which is characterized by an axis 20. Axis 20 is not limited to the vertical direction shown in FIG. 1, but rather may be any direction.

Support structure 12 and horizontal support bar 14 may be composed of any solid material, such as plastic, differing materials being advantageously suited to distinct applications. Horizontal support bar 14 and gripping collar 22 may be an integral device. Gripping collar 22 may, for example, be shaped as a split collet that expands to receive an end of mast 18. Mounting device 16 and mast 18 may also be structurally integrated for rigidity and convenience of production.

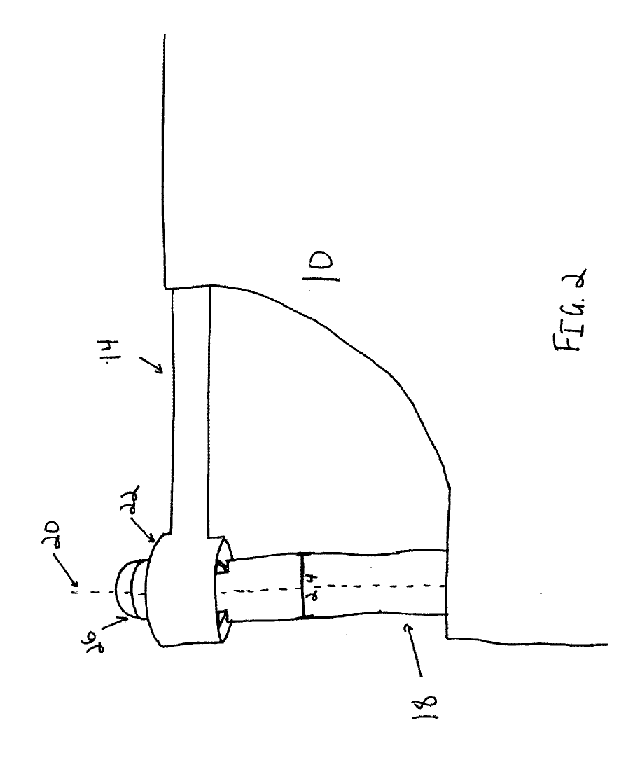

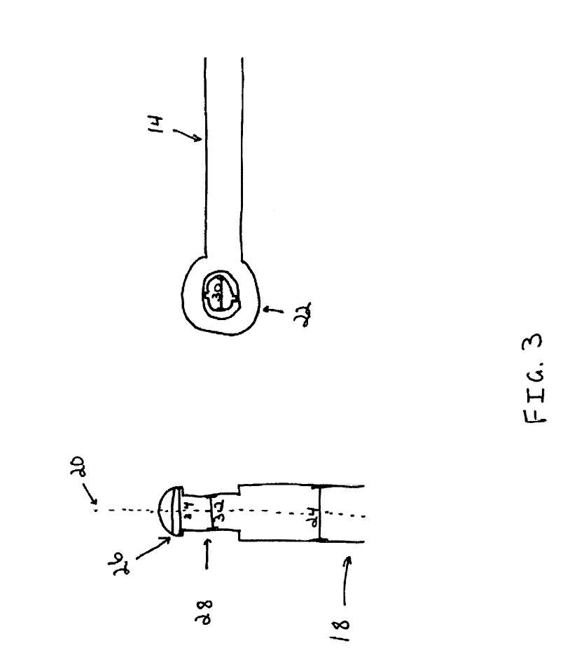

Mast 18 and gripping collar 22 are shown in further detail in FIG. 2 and FIG. 3. In FIG. 2, horizontal support bar 14 is coupled to mast 18 by gripping collar 22, such that horizontal support bar 14 is capable of rotating about axis 20. This allows display 10 to face any direction that is perpendicular to the direction of axis 20. Mast 18 is characterized by an outside diameter 24, a guide stop 26, and a receiving space 28, which is shown in FIG. 3. Outside diameter 24 of mast 18 is larger than the diameter 30 of gripping collar 22. Outside diameter 24 is also larger than the diameter 32 of receiving space 28. The diameter 34 of guide stop 26 is further larger than diameter 30 of gripping collar 22. When horizontal support bar 14 is coupled to mast 18, gripping collar 22 passes over guide stop 26, and rests on mast 18. Gripping collar 22 thus surrounds receiving space 28. Guide stop 26 prevents gripping collar 22 from being uncoupled from mast 18 until a user so desires.

To display a flag on the invention, a user would first couple gripping collar 22 of horizontal support bar 14 to mast 18 of support structure 12, as shown in FIGS. 1 and 2. A flag could then be simultaneously attached to horizontal support bar 14 and mast 18. Support structure 12 with the flag could then be attached to, for example, a car window by using mounting device 16.

The present invention may be embodied in other specific forms without departing from the true scope of the invention. The described embodiments are to be considered in all respects as illustrative only and not restrictive.

What is claimed is:

1. A display assembly, comprising:
a. a support structure having first and second ends, wherein the first end of the support structure is for coupling to a fixture, and wherein the second end of the support structure comprises a mast characterized by an axis; and
b. a horizontal support bar having a gripping collar, the gripping collar capable of being coupled to the mast in such a manner as to permit the horizontal support bar to rotate about the axis of the mast.

2. A display assembly according to claim 1, wherein the mounting device includes a bracket.

3. A display assembly according to claim 2, wherein the mast is substantially cylindrical and is characterized by an outside diameter.

4. A display assembly according to claim 3, wherein the mast comprises a guide stop for passing through the gripping collar and a receiver space that fits inside the gripping collar.

5. A display assembly according to claim 4, wherein the receiver space is characterized by a diameter smaller than the diameter of the mast.

6. A display assembly according to claim 5, wherein the gripping collar has an inner diameter smaller than the outer diameter of the mast.

7. A display assembly according to claim 6, wherein the guide stop has a diameter larger than the inner diameter of the gripping collar.

8. A display assembly according to claim 7, wherein a display is simultaneously coupled to the mast and the horizontal support bar.

9. A display assembly according to claim 8, wherein the display is a flag.

10. A display assembly according to claim 9, wherein the support structure and the horizontal support bar are composed of a solid material.

11. A display assembly according to claim 10, wherein the horizontal support bar and the gripping collar are integral.

12. A display assembly according to claim 11, wherein the mounting device and the mast are integral.

13. A method for displaying a flag, comprising:
a. coupling a gripping collar of a horizontal support bar to a mast of a support structure, wherein the mast is characterized by an axis and the horizontal support bar is capable of rotating about the axis of the mast; and
b. attaching a flag simultaneously to the horizontal support bar and to the mast of the support structure.

14. A method according to claim 13, wherein the support structure includes a mounting device, and the method further comprises coupling the mounting device to a fixture.
